(19) United States
(12) Patent Application Publication
(10) Pub. No.: US 2024/0093646 A1
(43) Pub. Date: Mar. 21, 2024

(54) METHOD AND COMPUTER PROGRAM PRODUCT FOR MONITORING A BLEED AIR SUPPLY SYSTEM OF AN AIRCRAFT

(71) Applicant: LUFTHANSA TECHNIK AG, Hamburg (DE)

(72) Inventors: Henrik Sebastian STEUDE, Hamburg (DE); Alexej DEMESCHKIN, Mainz (DE)

(21) Appl. No.: 18/549,599

(22) PCT Filed: Mar. 3, 2022
(86) PCT No.: PCT/EP2022/055336

§ 371 Date: Sep. 8, 2023

(30) Foreign Application Priority Data
Mar. 10, 2021 (EP) 21161673.5

(51) Int. Cl. F02C 9/18

(52) U.S. Cl. CPC F02C 9/18; B64D 2045/0085

(57) ABSTRACT

A method monitors a bleed air supply system of an aircraft, the bleed air supply system having at least two analog sensors for monitoring a state of the bleed air supply system based on sensor data. The method includes: determining at least one characteristic map point cloud from simultaneously acquired sensor data from two respective analog sensors, of the at least two analog sensors, relating to the state of the bleed air supply system over a predefined minimum period of time; comparing the characteristic map point cloud with a corresponding predefined characteristic curve for a relationship between the simultaneously acquired sensor data that is represented by the characteristic map point cloud; and based upon a deviation of the characteristic map point cloud from the predefined characteristic curve beyond a predefined amount being detected: outputting a warning.

### CROSS REFERENCE TO RELATED APPLICATIONS

This application is a U.S. National Phase application under 35 U.S.C. § 371 of International Application No. PCT/EP2022/055336, filed on Mar. 3, 2022, and claims benefit to European Patent Application No. EP 21161673.5, filed on Mar. 10, 2021. The International Application was published in German on Sep. 15, 2022 as WO 2022/189235 A1 under PCT Article 21(2).

### FIELD

The present disclosure relates to a method and a computer program product for monitoring a bleed air supply system of an aircraft.

### BACKGROUND

In aircraft, in particular commercial aircraft, compressed air is bled out of the turbo compressor of an engine in order to be able to generate or maintain a desired pressure in a pressurized cabin or in pneumatic systems of the aircraft. The engines can be jet engines, propeller turbines or auxiliary power units (APUs). It is customary to equip each engine of an aircraft with a separate bleed air supply system, inter alia in order to also ensure redundancy.

The bleed air is extracted from an engine by a bleed air supply system and fed to the various consumers. The bleed air supply system basically has various actuators, in particular controllable or self-regulating valves, pressure and temperature sensors or transducers and, if necessary, a control unit which can actuate the actuators on the basis of the determined pressure and temperature values and possibly external control signals. It is also possible to dispense with a control unit, in which case purely pneumatic regulation of the individual actuators can then be implemented. In both cases, in addition to maintaining a desired operating pressure, the temperature of the compressed air made available to the various consumers can also be regulated in principle.

Bleed air supply systems have a low level of reliability due to the many mechanical components, especially in the case of purely pneumatic regulation. If a fault occurs, the bleed air supply system must fundamentally be switched off for safety reasons, even if the frequent failures can sometimes cause significant disturbances in the operation of an aircraft, in particular a commercial aircraft.

In order to be able to detect faults of a bleed air supply system during a flight, the values determined by the pressure and temperature sensors of the bleed air supply system can be monitored, wherein usually only a check with respect to predefined threshold values with sometimes long confirmation times is carried out in the prior art. In such a system, if a threshold value is exceeded by a measured value, the entire bleed air supply system is deactivated as a precaution. This form of monitoring does not make it possible to consider the dynamic behavior of the components or to actively assess the state of the bleed air system.

Although this monitoring of the bleed air supply system is capable of detecting possible faults in the bleed air supply system and deactivating the system if necessary, the monitoring devices known from the prior art do not provide any detailed information on the possible cause of a fault in the bleed air supply system in the fault messages, with the result that a fault requires complex troubleshooting and remedial measures on a regular basis.

Deactivating the bleed air supply system in the event of faults also has the disadvantage that, when a system is deactivated, the further bleed air supply system(s) of the aircraft must additionally provide the bleed air of the deactivated bleed air supply system, which increases the wear and also the risk of failure of the further bleed air supply systems.

The document U.S. Pat. No. 9,555,903 B2 describes a method for diagnosing faults in the bleed air supply system, in which various sensors arranged on the bleed air supply system are read out and the respective sensor data are checked for deviations from comparison values. The comparison values may be firmly predefined values, parameters determined from operating parameters of the engine and the associated bleed air supply system, (average) values determined in the past for the bleed air supply system in question, or average values determined in the past for all bleed air supply systems in a series.

Any deviations that may be detected can be interpreted in a flight-phase-specific manner, that is to say, for example, separately for the take-off, ascent, descent and cruising flight phases. In individual cases, specific deviations of the sensor values from the comparison values in predefined flight phases can then possibly be assigned to specific faults in the bleed air supply system. On the other hand, for example, an excessively low pressure in the ascent or cruising flight phase actually cannot be uniquely assigned to any component or at least can be uniquely assigned to a small group of components. At least in some of the fault messages, there is also no actual restriction of the possibly faulty components of the bleed air supply system in the method according to U.S. Pat. No. 9,555,903 B2, as a result of which the troubleshooting is very complex in such a fault case.

### SUMMARY

In an embodiment, the present disclosure provides a method for monitoring a bleed air supply system of an aircraft, the bleed air supply system having at least two analog sensors for monitoring a state of the bleed air supply system based on sensor data. The method includes: determining at least one characteristic map point cloud from simultaneously acquired sensor data from two respective analog sensors, of the at least two analog sensors, relating to the state of the bleed air supply system over a predefined minimum period of time; comparing the characteristic map point cloud with a corresponding predefined characteristic curve for a relationship between the simultaneously acquired sensor data that is represented by the characteristic map point cloud; and based upon a deviation of the characteristic map point cloud from the predefined characteristic curve beyond a predefined amount being detected: outputting a warning.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a detailed illustration of a bleed air system designed to carry out the method according to the present disclosure;

FIG. 2 shows a schematic illustration of the bleed air system from FIG. 1;

FIG. 3a and FIG. 3b show a first example of a characteristic map checked in the method according to the present disclosure;

FIG. 4a and FIG. 4b show a second example of a characteristic map checked in the method according to the present disclosure;

FIG. 5 shows exemplary illustrations of classifiable deviations from a first predefined characteristic curve; and

FIG. 6a and FIG. 6b show exemplary illustrations of classifiable deviations from a second predefined characteristic curve.

### DETAILED DESCRIPTION

Aspects of the present disclosure provide a method and a computer program product for monitoring a bleed air supply system of an aircraft, which is improved compared to the prior art.

The present disclosure relates to a method for monitoring a bleed air supply system of an aircraft, having:
at least two analog sensors for monitoring the state of the bleed air supply system based on the sensor data;
   having the steps of:
determining at least one characteristic map point cloud from the simultaneously acquired sensor data from two respective analog sensors relating to the state of the bleed air supply system over a predefined minimum period of time;
comparing the characteristic map point cloud with a predefined characteristic curve for the relationship between the acquired sensor data that is represented by the characteristic map point cloud; and
if a deviation of the characteristic map point cloud from the predefined characteristic curve beyond a predefined amount is detected: outputting a warning.

Furthermore, the present disclosure relates to a computer program product or a set of computer program products comprising program parts which, when loaded into a computer or into computers networked to each other, are designed to monitor a bleed air supply system of an aircraft, having at least two analog sensors for monitoring the state of the bleed air supply system based on the sensor data, according to the method according to the present disclosure.

First of all, some terms used in connection with the present disclosure will be explained.

An “analog sensor” is a sensor that can record physical properties of a component or in its environment as a quantitative measurement variable. The recorded measurement variable is provided as analog or—as a rule—digital sensor data. Typical examples of analog sensors are pressure sensors, temperature sensors or absolute encoders. The opposite of “analog sensor” is a “binary sensor” which, as a state sensor, can only qualitatively confirm the presence of a certain defined state, e.g. whether or not a valve is closed. Corresponding state information determinable by a binary sensor (“binary sensor data”) can also be derived from the sensor data from an analog sensor by comparing the quantitative sensor data with a limit value, e.g. by comparing the valve position detected by an absolute encoder with a limit value in order to determine whether the valve is closed.

In principle, relationships between sensor data from two different analog sensors can be represented in a “characteristic map”. Measured values determined by the two analog sensors at the same time can be represented as points with the measured values as coordinates. If a plurality of corresponding points are represented in a characteristic map over time, the result is a “characteristic map point cloud”.

For sensor data from two different analog sensors, a target relationship can be predefined in the form of a “characteristic curve”. A corresponding characteristic curve usually reflects the relationship between the sensor data from two analog sensors that can be expected in principle during fault-free operation. The characteristic curve can be obtained from a theoretical model of the bleed air supply system or from historical data relating to one or more structurally identical bleed air supply systems. The characteristic curve can be represented by mathematical functions, if necessary in sections, or by a polygon course predefined using coordinate pairs.

The present disclosure has recognized that the fault diagnosis and fault prediction can be significantly improved in a bleed air supply system if, instead of the temporal observation of individual state values of a bleed air supply system that is known from the prior art, recourse is had to one or more characteristic maps of respective sensor data from two respective analog sensors which monitor the state of the bleed air supply system. Depending on the choice of analog sensors for a specific characteristic map, different components and/or different functions of the components of the bleed air supply system can be monitored. In particular, dynamic states of the bleed air supply system, which virtually cannot be evaluated when considering measured values in the time series, can be easily evaluated using the characteristic maps. This makes it possible to precisely monitor, in particular, the valves of the bleed air supply system that are particularly subject to wear.

The analog sensors used for this purpose can be directly assigned to the bleed air supply system. However, it is also possible for an analog sensor to be arranged in a component of the aircraft upstream or downstream of the bleed air supply system, for example the engine. The only important factor is that the analog sensor records a measurement variable that has a direct influence on the bleed air supply system, e.g. the pressure prevailing in the engine in the region of a bleed point of the bleed air supply system.

A characteristic map point cloud determined by the analog sensors can vary greatly depending on the operating state of the bleed air valve or the aircraft, in particular its engine. This means that the characteristic map point cloud can change depending on the position of different valves of the bleed air valve and/or the speed of the engine. In order to nevertheless make it possible to easily evaluate the characteristic maps, e.g. in the comparison with a characteristic curve, in a preferred embodiment, the operating-state-dependent characteristic maps are determined, wherein the operating state of the bleed air supply system is predefined by a control unit of the bleed air supply system or the aircraft and/or is determined by state sensors on the bleed air supply system or on the aircraft.

If the bleed air supply system comprises at least one pressure control valve, it may be preferred if its activation state characterizes different operating states for which different characteristic maps are determined. The activation state can be in particular a binary statement, for example whether a certain valve is blocked. The binary blocking state is binary sensor data.

In the case of bleed air supply systems, air is often bled at at least two different pressure stages of the compressor of an engine, wherein a separate pressure control valve is then provided at at least one bleed point. The binary blocking state of this separate pressure control valve can characterize different operating states of the bleed air supply system.

It is also possible for one or more (also operating-state-dependent) characteristic maps to be parameter-dependent, i.e., in addition to the two items of sensor data to be related, at least one further parameter is also taken into account in the characteristic value point cloud and the predefined characteristic curve. The at least one additional parameter may preferably be a by an analog sensor for monitoring the state of the bleed air supply system or the environment or a non-binary operating state value of the aircraft.

For example, the parameter for parameter-dependent characteristic maps can be the flow rate through the bleed air supply system, as recorded by an analog sensor provided for this purpose, and/or the air temperature recorded by an analog sensor provided for this purpose in the bleed air supply system or in the engine. The engine target speed predefined by the controller or the pressure measured or derived from other variables in predefined areas within the engine or in the environment can also be used as parameters. The consumption of the bleed air and the associated demand on the bleed air supply system can also be taken into account as parameters.

In a preferred embodiment, characteristic map point clouds are determined over discrete, non-overlapping time periods, with the result that a trend analysis can be carried out on the basis of two or more characteristic map point clouds for different time periods. Signs of wear on components of the bleed air supply system can be represented in a corresponding trend analysis and a possibly worn component can be replaced proactively before wear-related failure of the component and possibly of the entire bleed air supply system occurs. The time periods can be selected according to actual flights performed by the aircraft, i.e. from the starting of the engines before take-off to the switching-off of the engines after landing. It is also possible for a time period to extend over a plurality of corresponding flights.

Possible detected deviations of the characteristic map point cloud from the predefined characteristic curve can also be classified. This is because it has been shown that different changes in a characteristic map point cloud, which lead to deviations from the associated characteristic curve, indicate different signs of wear and/or faults, if any, of a respective particular component. By classifying the detected deviation, the actual cause of the fault can often be identified directly.

In a preferred embodiment, the bleed air supply system comprises at least one analog pressure sensor whose sensor data are acquired and taken into account when determining the characteristic map point cloud. In particular, at least two analog pressure sensors may also be provided at different points of the bleed air supply system, the sensor data from which together form a characteristic map point cloud.

The method can be implemented in the computer program product or set of computer program products. For the possible classification of detected deviations, an expert system can be provided.

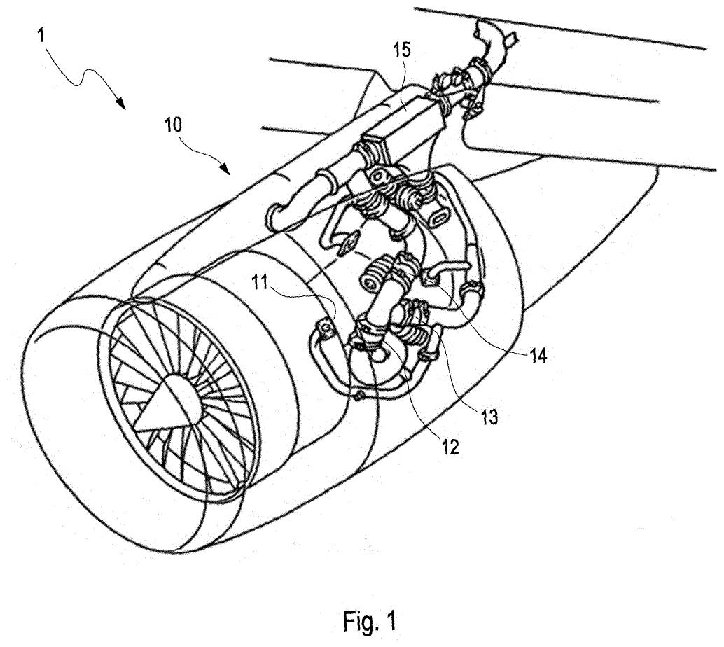

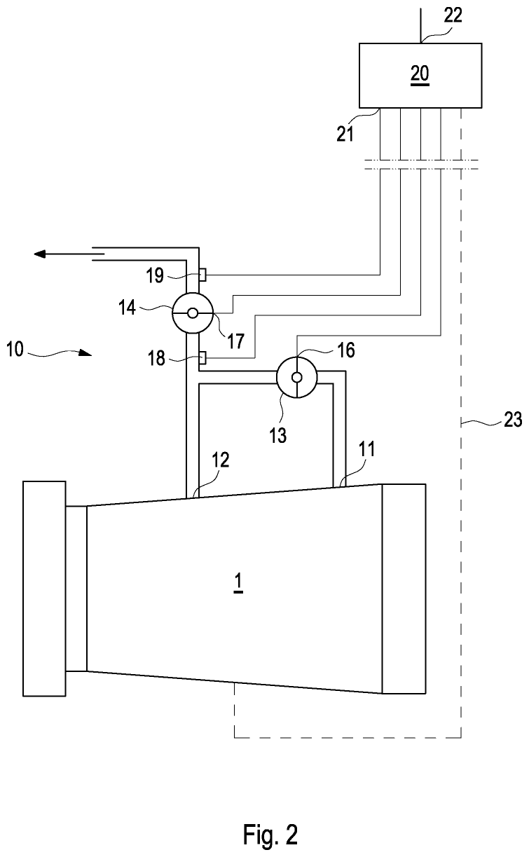

FIGS. 1 and 2 show a bleed air supply system 10 designed to carry out a method according to the present disclosure on the engine 1 of an aircraft, wherein FIG. 1 shows the bleed air supply system 10 structurally on the engine 1, while FIG. 2 shows a schematic functional sketch of the bleed air supply system 10 exclusively to the extent relevant for carrying out the method according to the present disclosure.

The bleed air supply system 10 has two bleed points 11, 12 in the region of the compressor stages of the engine 1, wherein one bleed point 11 is arranged in the region of the outlet of the high-pressure compressor of the engine 1, while the other bleed point 12 is arranged in a region of the engine 1 at lower pressure.

The bleed point 11 in the region of the outlet of the high-pressure compressor of the engine 1 is assigned a first control valve 13, the high-pressure valve, whose outlet is connected to the bleed point 12. The bleed point 12 and the outlet of the high-pressure valve 14 are connected to a further control valve 15, the pressure control valve. From there, the bleed air may pass through a heat exchanger 15 (cf. FIG. 1) for cooling the bleed air to the consumers or into a compressed air supply network.

The control valves 13, 14 can be self-regulating valves or valves actively controlled by a control unit via control lines. In both cases, the bleed air is basically supplied on the basis of, among other things, the operating state of the engine 1 and the air requirements of the consumers connected directly or via a compressed air supply network.

A monitoring unit 20 is provided for the purpose of monitoring the bleed air supply system 10 and comprises a computer on which a computer program product according to the present disclosure is loaded. The monitoring unit 20 may be arranged directly on the bleed air supply system 10, remote from it on board the aircraft or outside the aircraft on the ground. In the latter case, the necessary data are transmitted via a radio connection.

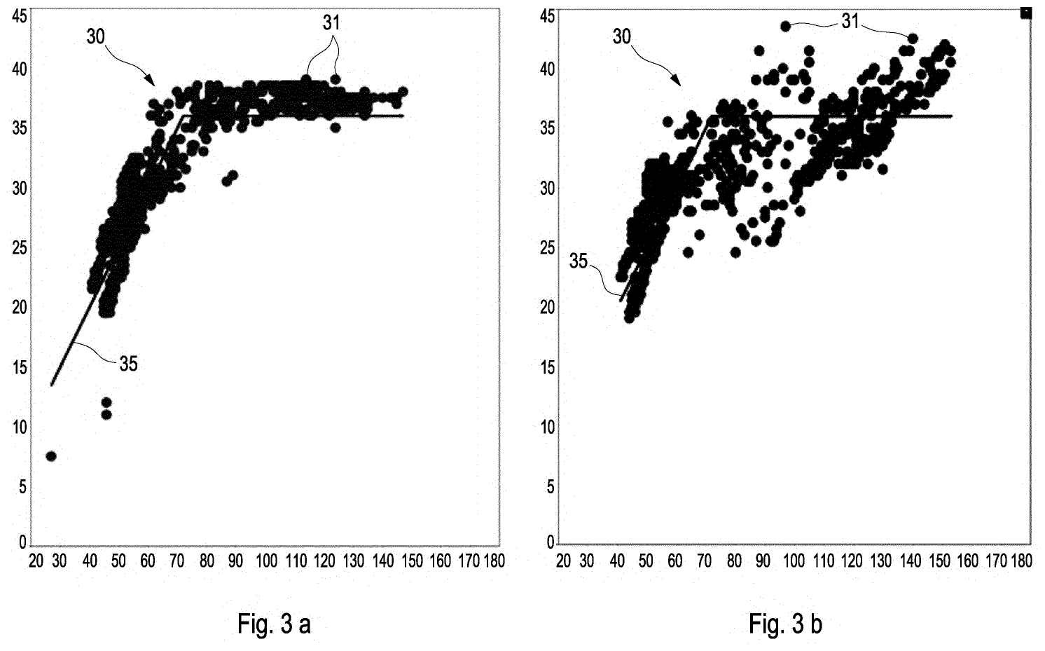

The monitoring unit 20 comprises a plurality of inputs 21 for analog and binary sensor data, as well as operating state information from the engine 1, and an output 22 for outputting any warnings. The warnings possibly generated by the monitoring unit 20 can be displayed, for example, in the aircraft cockpit, or they are forwarded to a maintenance company that can then prepare for the maintenance of the bleed air system. Alternatively or additionally, the output 22 can be used to output graphical characteristic map representations, as shown in FIGS. 3 to 6 for example, for further evaluation by a maintenance technician.

With the inputs 21, the on the valves 13, 14 binary sensors 16, 17 are arranged, wherein the binary sensor 16 associated with the high-pressure valve 13 indicates the blocking position of the high-pressure valve 13, that is to say outputs logic yes as sensor data when the high-pressure valve 13 is completely closed. The sensor data from the binary sensor 17 on the pressure control valve 14 are logic yes when the pressure control valve 14 is completely open.

In addition, two analog pressure sensors 18, 19 are also connected to the inputs of the monitoring unit 20. The analog pressure sensor 18 is used to record the pressure in the supply line upstream of the pressure control valve 14, while the analog pressure sensor 19 records the regulated pressure downstream of the pressure control valve 14.

The monitoring unit 20 is also connected via a data line 23 to a control and/or monitoring unit of the engine 1 and/or the aircraft and receives from there further operating data and operating parameters of the engine 1 and/or the aircraft. In the example illustrated, the monitoring unit 20 is supplied with the relative excess pressure relative to the environment within the engine in the region of the bleed point 11, i.e. downstream of the high-pressure compressor of the engine 1, via the data line 23 as analog sensor data. In addition, the monitoring unit 20 can also be supplied, via the data line 23, with the temperatures of the air at various points of the engine 1, which can be taken into account as additional parameters during the characteristic map determination described below.

Different characteristic maps are used on the basis of the operating states of the bleed air supply system 1 that can be read by the binary sensors 16, 17.

If the engine 1 is idling, with the result that no bleed air at a sufficient pressure is available at the bleed point 12, recourse is had to the bleed point 11 downstream of the high-pressure compressor of the engine 1, at which there is sufficient pressure for the bleed air supply even when the engine 1 is idling. In this case, in the exemplary embodiment illustrated, the pressure control valve 14 is completely opened and the pressure is controlled solely by suitably controlling the high-pressure valve 13.

In this operating state, the binary sensor 16 thus reports a logic no to the monitoring unit 20 (the high-pressure valve 13 is at least not completely closed), while the binary sensor 17 outputs a logic yes, since the pressure control valve 14 is completely open in this operating state. The monitoring unit 20 can determine, on the basis of the sensor data from the two binary sensors 16, 17, the operating state of the bleed air system 10 intended for idling of the engine 1.

For this operating state, provision is made, as the characteristic map, for the pressure in the supply line to the pressure control valve 14 to be represented on the basis of the excess pressure prevailing in the area of the bleed point 11 in the engine 1 in relation to the environment. The pressure in the supply line to the pressure control valve 14 is recorded by the analog pressure sensor 18, while the pressure in question in the interior of the engine 1, which corresponds to the pressure downstream of the high-pressure compressor, is available via the data line 23 as analog sensor data. The latter sensor data are acquired by an analog sensor in the engine 1. The individual measured values are time-coded, with the result that pairs of values 31 can be formed from measured values recorded at the same time from the sensor data, thus resulting in a characteristic value point cloud 30.

FIG. 3a illustrates, by way of example, a corresponding characteristic value point cloud 30 comprising a multiplicity of pairs of values 31. The excess pressure relative to the environment at the bleed point 11 is illustrated on the x-axis, and the pressure recorded by the analog pressure sensor 18 is illustrated on the y-axis.

For the same context, an operating-state-dependent characteristic curve 35, which represents the ideal dependence of the two values considered, is provided.

As can be seen in FIG. 3a, the characteristic value point cloud 30 adequately matches the characteristic curve 35—taking into account conventional measurement inaccuracies and tolerances—with the result that no warning has to be output in the example illustrated. The monitoring unit 20 is designed to carry out this very same check, but no warning is output via the output 22 in this case.

FIG. 3b shows a characteristic value point cloud 30 illustrated and determined in an identical manner to FIG. 3a, wherein, due to the considerable scattering of the pairs of values 31 at higher pressures at the bleed point 11 (x-axis), a considerable deviation from the characteristic curve 35 can be determined—also by the monitoring unit 20, with the result that a warning can be output via the output 22. The deviation shown in FIG. 3b shows a faulty behavior of the valve 16, with the result that the troubleshooting can be restricted the valve 16 (e.g. mechanical wear or leaks) or its control. More detailed statements about the cause of the fault solely on the basis of the deviations determined can be made, if necessary, by virtue of a corresponding comparison with previous similar deviations and their respective cause of the fault.

During the actual flight of the aircraft, the engine 1 is no longer idling and the bleed air supply system 10 is also in a different operating state. In this state, sufficient pressure is usually available at the bleed point 12 for the bleed air supply, with the result that the high-pressure valve 13 is completely closed and the pressure is controlled exclusively via the pressure control valve 14. The operating state can be determined by the monitoring unit 20 again solely via the sensor data from the binary sensors 16, 17, since the binary sensor 16 outputs a logic yes for a completely closed high-pressure valve 13 and the binary sensor 17 outputs a logic no for an incompletely open pressure control valve 14.

For this operating state, provision is made, as the characteristic map, for the pressure downstream of the pressure control valve 14 to be represented on the basis of the pressure upstream of the pressure control valve 14. The first-mentioned pressure is recorded by the analog pressure sensor 19, while the pressure in the supply line to the pressure control valve 14 is recorded by the analog pressure sensor 18. The individual measured values are each gathered at the same time, with the result that pairs of values 31 can each be formed from measured values recorded at the same time from the sensor data, thus resulting in a characteristic value point cloud 30.

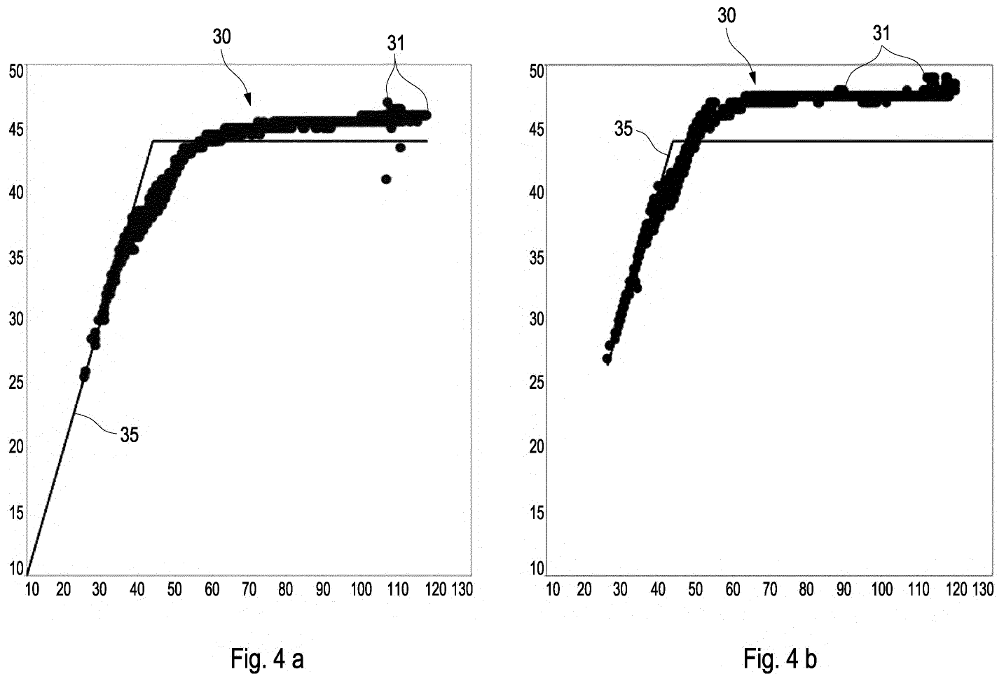

FIG. 4a illustrates, by way of example, a corresponding characteristic value point cloud 30 comprising a multiplicity of pairs of values 31. The pressure recorded by the analog pressure sensor 18 upstream of the pressure control valve 14 is illustrated on the x-axis, and the pressure recorded by the analog pressure sensor 18 downstream of the pressure control valve 14 is illustrated on the y-axis.

A corresponding, predefined characteristic curve 35 for the target dependence of the two values is also illustrated in FIG. 4a.

The deviations of the characteristic value point cloud 30 from the characteristic curve 35 in FIG. 4a is still in the permissible tolerance range that can be checked by the monitoring unit using known mathematical methods, with the result that no warning must or will be output in the example illustrated.

FIG. 4b shows a characteristic value point cloud 30 illustrated and determined in an identical manner to FIG. 4a. In this example, however, the characteristic value point cloud 30 has been shifted significantly “upward” compared to FIG. 4a, which results in a significant deviation from the characteristic curve 35. This deviation is detected by the monitoring unit 20 as exceeding a predefined tolerance and consequently a warning is output via the output 22. The deviation shown in FIG. 4b shows a faulty behavior of the valve 14, with the result that the troubleshooting can be restricted the valve 14 (e.g. mechanical wear or leaks) or its control. More detailed statements about the cause of the fault solely on the basis of the deviations determined can be made, if necessary, by virtue of a corresponding comparison with previous similar deviations and their respective cause of the fault.

Conclusions about the type of defect can be derived directly from certain deviations of a characteristic value point cloud 30 from the associated characteristic curve 35. The determined deviations are classified for this—e.g. also directly by the monitoring unit 20, wherein, with a sufficiently unambiguous classification by the monitoring unit 20, the latter can output corresponding information via the output 22.

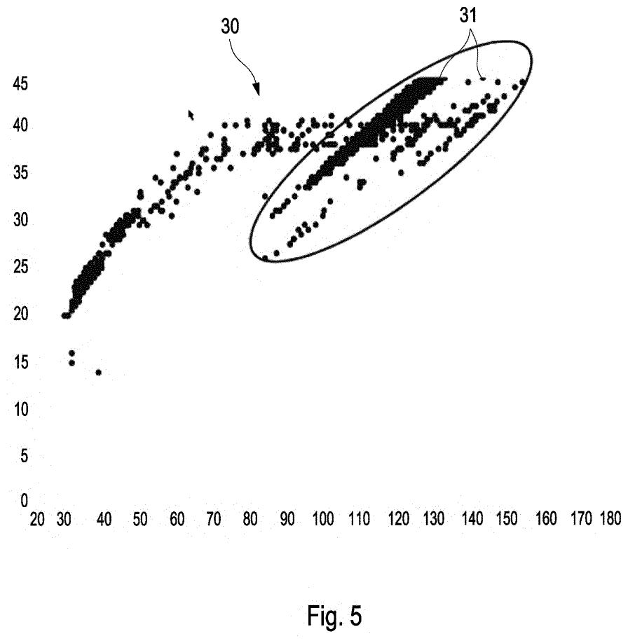

FIG. 5 shows a characteristic value point cloud 30 according to FIGS. 3a, b, in which the circled pattern of pairs of values 31 allows the conclusion that the binary sensor 16 is defective or provides faulty sensor data. This is because if the binary sensor 16 were to correctly output a logic yes when the high-pressure valve 13 was actually closed, the pairs of values 31 in question, which reflect the pressure control by the pressure control valve 15, would not be recorded in this characteristic map, as illustrated in FIG. 5 (cf. statements made with respect to the operating state in FIG. 3a).

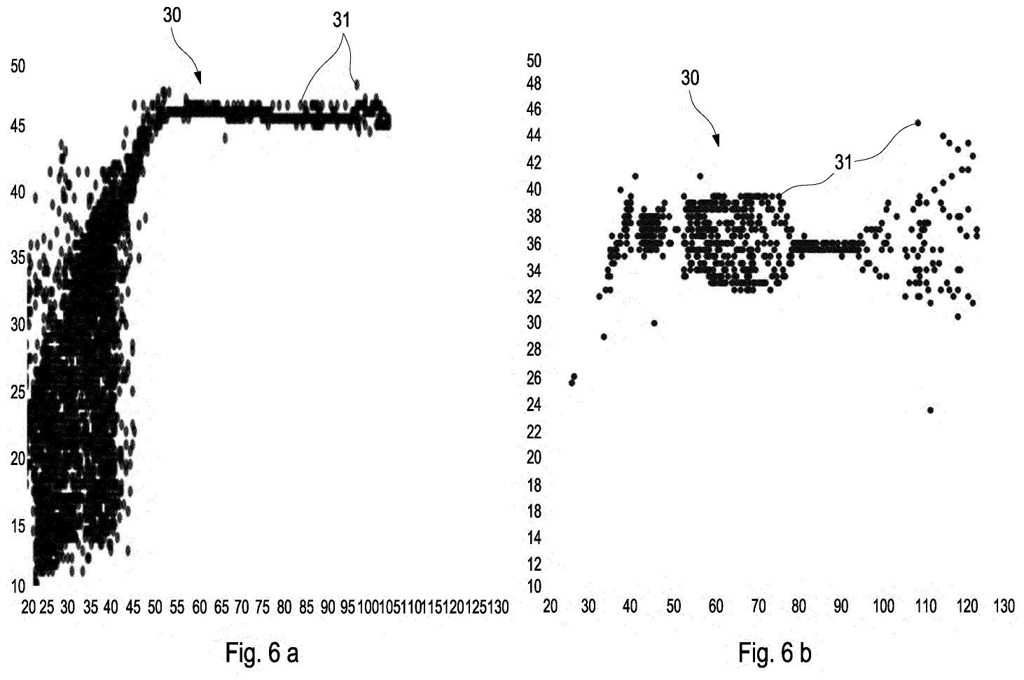

FIGS. 6a, b show further examples of classifiable deviations from the characteristic curve 35 in the case of characteristic value point clouds 30 according to FIGS. 4a, b.

The characteristic value point cloud 30 shown in FIG. 6a indicates that the pressure control valve 14 is not being controlled properly. The characteristic value point cloud 30 from FIG. 6b indicates a worn pressure control valve 13.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for monitoring a bleed air supply system of an aircraft, the bleed air supply system comprising at least two analog sensors for monitoring a state of the bleed air supply system based on sensor data, the method comprising:
determining at least one characteristic map point cloud from simultaneously acquired sensor data from two respective analog sensors, of the at least two analog sensors, relating to the state of the bleed air supply system over a predefined minimum period of time;
comparing the characteristic map point cloud with a corresponding predefined characteristic curve for a relationship between the simultaneously acquired sensor data that is represented by the characteristic map point cloud; and
based upon a deviation of the characteristic map point cloud from the predefined characteristic curve beyond a predefined amount being detected: outputting a warning.

2. The method as claimed in claim 1, the method further comprising:
determining operating-state-dependent characteristic maps, wherein an operating state of the bleed air supply system is predefined by a control unit of the bleed air supply system or the aircraft and/or is determined by state sensors on the bleed air supply system or on the aircraft.

3. The method as claimed in claim 1, wherein:
the bleed air supply system comprises at least one pressure control valve, the activation state of which, preferably the binary blocking state of which, characterizes different operating states.

4. The method as claimed in claim 1, the method further comprising determining:
parameter-dependent characteristic maps, wherein a parameter for the parameter-dependent characteristic maps represents an analog sensor for monitoring the state of the bleed air supply system or the environment or a non-binary operating state value of the aircraft.

5. The method as claimed in claim 1, wherein:
parameters for parameter-dependent characteristic maps comprise a flow rate through the bleed air supply system, as recorded by an analog sensor provided for this purpose, and/or an air temperature recorded by an analog sensor provided for this purpose in the bleed air supply system or in the engine.

6. The method as claimed in claim 1, further comprising
determining at least wide characteristic map point clouds over discrete, non-overlapping time periods, and carrying out a trend analysis using appropriately recorded characteristic map point clouds for different time periods.

7. The method as claimed in claim 1, wherein:
detected deviations of the characteristic map point cloud from the predefined characteristic curve are classified.

8. The method as claimed in claim 1, wherein:
the bleed air supply system comprises at least one analog pressure sensor whose sensor data are acquired and taken into account when determining the characteristic map point cloud.

9. A non-transitory computer readable medium comprising a computer program product or set of computer program products comprising program parts which, when loaded into a computer or into computers networked to each other, are designed to monitor a bleed air supply system of an aircraft, having at least two analog sensors for monitoring the state of the bleed air supply system based on the sensor data, according to the method as claimed in claim 1.
